(19) United States
(12) Patent Application Publication
(10) Pub. No.: US 2008/0310712 A1
(43) Pub. Date: Dec. 18, 2008

(54) Method and system to detect and correct whiteness with a digital image

(76) Inventor: Albert D. Edgar, Austin, TX (US)

Correspondence Address: Image Trends, Inc., Building One, Suite 450, 6300 Bridgepoint Parkway, Austin, TX, 78641, US

(21) Appl. No.: 12/157,676

(22) Filed: Jun. 12, 2008

Related U.S. Application Data
(60) Provisional application No. 60/934,250, filed on Jun. 12, 2007.

(51) Int. Cl. G06K 9/03

(52) U.S. Cl. 382/167

(57) ABSTRACT

A method and system to detect and correct teeth whiteness within a digital image is disclosed. Many images would be more aesthetically pleasing if the teeth of individuals within the image were whitened to reduce discoloration. In one embodiment of the present invention, the teeth of individuals within a digital image are automatically detected. The color of the teeth are then whitened to a more aesthetically pleasing level.

### CROSS REFERENCE TO RELATED APPLICATIONS

This application claims priority under 35 U.S.C. 119(e) to U.S. Provisional Patent Application No. 60/934,250, entitled Method and System to Detect and Correct Teeth Whiteness Within a Digital Image, having a priority filing date of Jun. 12, 2007.

### FIELD OF THE INVENTION

This invention generally relates to digital imaging and more specifically to a method and system to detect and correct whiteness within a digital image.

### BACKGROUND OF THE INVENTION

The photography market has exploded with the wide adoption of digital imaging in traditional cameras, mobile phones and video cameras. Digital cameras are used to capture the moment, but can also capture certain unwanted detail that users would like to correct to a more desirable level. One consistent problem is the color of teeth, which are often dulled by light or are naturally discolored. The images would be more visually appealing if the teeth were whitened. Other areas of an image that would be more appealing by whitening are the eye, pearls and other such off-white features.

Whitening is conventionally corrected by manually “touching-up” the image using one of many conventional photo editing software solutions. In short, the operator views the image and manually defines the object to be whitened. Using brushes or fill techniques, the operator then whitens the object. Manually correcting each image is generally expensive, difficult and cannot be easily done to most images. It also does not generally maintain the feature detail of the object, making it look unnatural or dislocated. Accordingly, an improved method and system for correcting discoloration within a digital image is needed.

### SUMMARY OF THE INVENTION

The present invention provides method and system for detecting and correcting whiteness within a digital image. In one embodiment of the present invention, a whiteness correction application operable to loaded into an electronic system is provided. In this embodiment, the whiteness correction application comprises software that operates to receive an original image; automatically detecting one or more off white objects within the original image; whiten at least a portion of the off white objects to create a corrected image that is more visually appealing than the original digital image; and output the corrected image. In the preferred embodiment, the off white objects whitened by the whiteness correction application are one or more teeth. In this preferred embodiment, detecting the teeth is accomplished by analyzing the color variations within the original image to detect one or more objects that may be teeth; determining whether the areas adjacent each object has skin tones; and filtering the objects based on the areas adjacent each object to determine which objects are teeth. The embodiment may further include the process of determining whether the areas adjacent each object has foliage tones. In yet another embodiment of the whiteness correction application, the application analyses the features of each face to detect the teeth.

In another embodiment of the present invention, an electronic system is provided. In this embodiment, a whiteness correction application is operable to be loaded onto one or more processors in the electronic system. The whiteness correction application operates to receive an original image; automatically detect one or more teeth within the original image; whiten at least a portion of the off white objects to create a corrected image that is more visually appealing than the original digital image; and output the corrected image. In this embodiment, the electronic system could be a computer, camera or scanner electronic system.

In yet another embodiment of the present invention, a method for whitening certain off white objects within an original image is provided. In one embodiment, the method comprises the steps of automatically detecting one or more off white objects within the original image and whitening at least a portion of the off white objects to create a corrected image that is more visually appealing than the original digital image.

At least one embodiment of this invention has the advantage of automatically detecting teeth and correcting the color of the teeth within the image. This results in images that are more visually appealing. Other advantages will be readily apparent to one skilled in the art from the following figures, descriptions, and claims.

### BRIEF DESCRIPTION OF THE DRAWINGS

For a more complete understanding of the invention and the advantages thereof, reference is now made to the following description taken in conjunction with the accompanying drawings, wherein like reference numerals represent like parts, in which:

FIGS. 1A-1C are schematic diagrams of electronic systems in accordance with particular embodiments of the present invention;

FIG. 2 is a flow diagram of a color morphology method for detecting and whitening off white objects within an original image in accordance with one embodiment of the invention; and

FIG. 3 is a flow diagram of a facial recognition method for detecting and whitening off white objects within an original image in accordance with one embodiment of the invention.

### DETAILED DESCRIPTION OF THE PREFERRED EMBODIMENTS

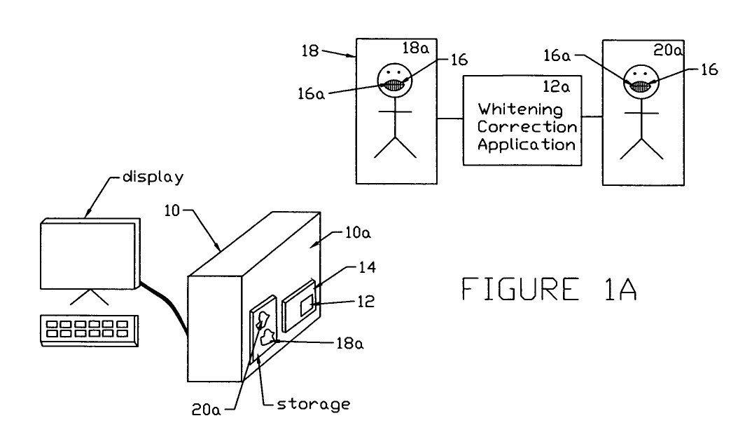

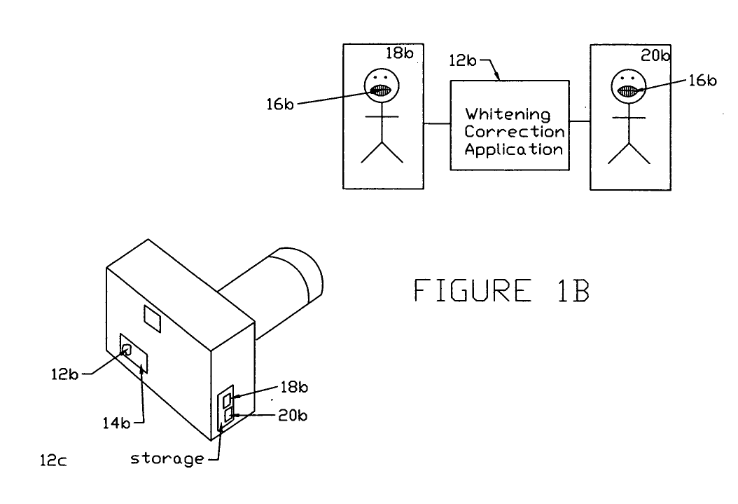

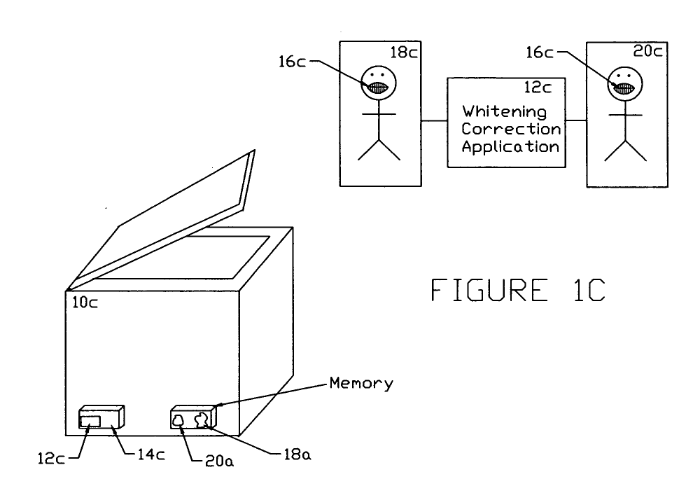

FIGS. 1A-1C illustrate certain electronic systems 10 that utilize a whiteness correction application 12 running on one or more processors 14 to detect and adjust the color of objects 16 within an original image 18 and produce a corrected image 20. In the preferred embodiment, the objects 16 are teeth and the color of the teeth are adjusted to make them appear whiter, without appearing unnatural and losing detail. The whiteness correction application 12 may also be used to enhance the color of the eye, pearls and other objects. The whiteness correction application 12 may also include other image correction/management functionality, such as resize, color management, format and other such functionality.

FIG. 1A illustrates a computer electronic system 10a. In this embodiment, the computer electronic system 10a includes one or more processors 14a. A whiteness correction application 12a is loaded into the computer electronic system 10a and runs on the processors 14a. The whiteness correction application 12a operates to receive an original image 18a from a source, such as a removable media drive, external imaging system, storage system or other such device (not shown). The whiteness correction application 12a operates to detect one or more objects 16a within the original image 18a. The whiteness correction application 12a adjusts the whiteness of the objects 16a and produces a corrected image 20a. The corrected image 20a can then be exported, displayed or stored.

FIG. 1B illustrates a camera electronic system 10b. In this embodiment, the camera electronic system 10b includes one or more processors 14b. A whiteness correction application 12b is loaded into the camera electronic system 10b and runs on the processors 14b. In this embodiment, the whiteness correction application 12b is generally optimized to operate on processors 14b having comparably low processing power. The whiteness correction application 12b operates to receive an original image 18b directly from the camera's optical sensor (not shown) or storage device (not shown) within the camera electronic system 10b. The whiteness correction application 12b operates to detect one or more objects 16b within the original image 18b. The whiteness correction application 12b adjusts the whiteness of the objects 16b and produces a corrected image 20b. The corrected image 20b can then be exported, displayed or stored.

FIG. 1C illustrates a scanner electronic system 10c, such as a flatbed scanner, copy machine, fax or other such scanning device. In this embodiment, the scanner electronic system 10c includes one or more processors 14c. A whiteness correction application 12c is loaded into the scanner electronic system 10c and runs on the processors 14c. The whiteness correction application 12c operates to receive an original image 18c directly from the scanner's optical sensor (not shown) or storage device (not shown) within the scanner electronic system 10c. The whiteness correction application 12c operates to detect one or more objects 16c within the original image 18c. The whiteness correction application 12c adjusts the whiteness of the objects 16c and produces a corrected image 20c. The corrected image 20c can then be exported, displayed or stored.

It will be understood that the electronic systems 10 may comprise any suitable device or system for running the whiteness correction application 12. It should also be understood that the electronic systems 10 may include other components and devices without departing from the scope and spirit of the present invention.

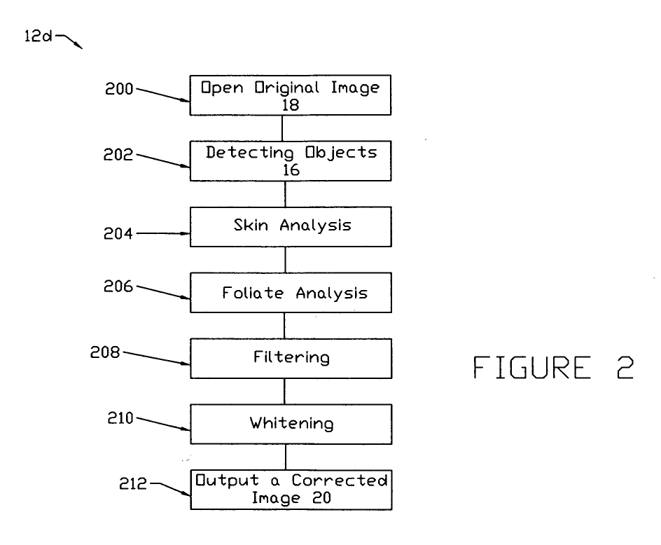

FIG. 2 is a flow diagram of a color morphology whiteness correction application 12d in accordance with one embodiment of the present invention. In this embodiment, the color morphology correction application 12d comprises the steps of receiving an original image (18) 200, detecting areas within the original image 18 that may be teeth (16) 202, skin analysis 204, foliate analysis 206, filtering 208, whitening 210 and outputting a corrected image (20) 212. As described below, the color morphology whiteness application 12d is described in terms of detecting and whitening teeth, but as discussed above, the application 12d can be applied to other objects 16 within the original image 18.

In step 200, the original image 18 is received and opened by the color morphology correction application 12d. In the preferred embodiment, the original image 18 is a color digital image with a suitable resolution. As illustrated in FIGS. 1A-1C, the original image 18 may be received from any suitable device, system or storage In step 202, a mask is created to find areas that could be teeth 16d. Teeth 16d can be in multiple subjects. As part of the analysis process, each image is evaluated based on several parameters of the image data. In the preferred embodiment, teeth 16d are located by producing a mask image, matched in register with the original image 18, in which each pixel is assigned a value of true or white if a pixel is likely to be over tooth, zero or black if it is unlikely to be over tooth, and intermediate if the disposition is uncertain. One way to assign these values to each pixel is by a series of layers that assign probabilities to each pixel based on morphologies in the image. These morphologies include attributes such as color, texture, and shapes in the image at and near the pixel being assigned.

The original image 18 will have a red record, green record, and blue record value either directly as in an RGB image or by mapping from a color space as in a YUV image. Since teeth vary from white to off-white, to yellow white, they tend to be light in the red and green record, and a darker in the blue. On the other hand surrounding skin and lips tend to be more pink or brown or darker yellow and therefore tend to be like teeth light in the red record, but darker than teeth in the green record and blue record. Therefore a morphological characteristic of a pixel over a tooth is that it will be lighter in the green and blue records than the average colors within a region, typically 100 pixels in radius.

In step 204, the areas that could be teeth 16d are analyzed based on the adjacent areas. In the preferred embodiment, each area is analyzed based on whether it is surrounded by skin tones. Skin can be found by its color characteristic in which the red channel is about 30% to 200% lighter than the green and blue channel. If the pixel candidate for tooth is near a region that averages to this color, the region being at least about 100 pixels across, the probability of being a tooth increases. Furthermore, if this color completely surrounds the candidate tooth, the probability is higher still. A further characteristic of teeth is that they are usually near lips that are reddish. Such a region can be distinguished as a small region, typically about 25 pixels across, in which the ratio of red to green is 2:1 up to 1:0, i.e. no green component. If the candidate tooth is close to such a region, the probability is higher still. Yet another characteristic of teeth is that they are near a mouth that has contrasting light and dark areas. Particularly in the red channel where teeth, skin, and lips appear white, the shadows internal to a mouth can be seen as quite dark. If the candidate tooth is proximal to a region, typically 50 pixels across, in which there is a wide variation of brightness in the red record, typically 2:1 or higher, the probability of being a tooth is higher still.

In optional step 206, the areas that could be teeth 16d are analyzed based on whether foliage is near the area. In the preferred embodiment, if the candidate area is immediately proximal to a region in which the yellow record averages well below the green record, and also the red record averages even a little below the green record, which is a characteristic of foliage, then the probability of the area being a white flower is higher and the probability of the area being a tooth is lower.

In step 208, the areas are filtered based on the analyses performed in steps 204 and 206 to determine which areas are likely teeth 16d and remove the areas that are not likely teeth 16d. The filtering can also include other features and morphology to further improve the identification of objects 16, i.e., teeth 16d. It should be understood that the filtering step 208 can be incorporated into the other steps.

In step 210, the areas identified as being teeth 16d are lightened. In the preferred embodiment, the most natural appearing lightening has been found to be to lighten the blue record primarily about 30%, the green record intermediately, and the red record little or none, thereby removing a yellowish cast. Furthermore it has been found that in addition to a simple rote lightening of the blue record, that substituting some of the value of the red record into the blue record, typically about 30%, will have a proportionate effect to the amount of yellowishness of the teeth, varying from no effect if the teeth are already white or gray, and having the strongest effect if the teeth are deep yellow, and therefore modulate correction in proportion to how much it is needed.

In step 212, the data from the original image 18 is combined with the data for lightening the teeth 16d to create a corrected image 20d. The corrected image 20d can then be output to a location selected by the user, such as a display, storage device or other system.

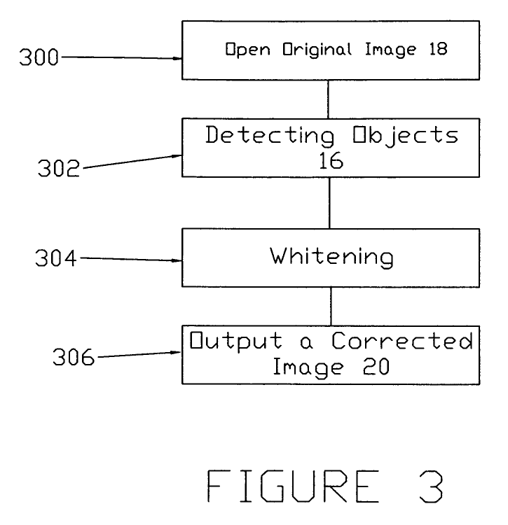

FIG. 3 is a flow diagram of a feature whiteness correction application 12e in accordance with one embodiment of the present invention. In this embodiment, the feature correction application 12e comprises the steps of receiving an original image (18) 300, detecting the teeth (16) 302, whitening 304 and outputting a corrected image (20) 306. To maintain consistency, the feature whiteness application 12e is described in terms of detecting and whitening teeth, but as discussed above, the application 12e can be applied to other objects 16 within the original image 18.

In step 300, the original image 18 is received and opened by the feature whiteness application 12e. As illustrated in FIGS. 1A-1C, the feature whiteness application 12e can operate on any suitable device and the original image 18 can be received from any such suitable device.

In step 302, the location of the teeth 16e are determined through feature recognition. In the preferred embodiment, facial recognition functionality is used to find the face and then the teeth 16e. Step 302 may utilize any suitable facial recognition software to detect the teeth 16e. For example, the facial recognition can be implemented through intensity variations and through the steps of localization, corner detection, facial feature matching and filtering to reject false matches.

In step 304, the areas identified as being teeth 16e are lightened. In the preferred embodiment, the most natural appearing lightening has been found to be to lighten the blue record primarily about 30%, the green record intermediately, and the red record little or none, thereby removing a yellowish cast. Furthermore it has been found that in addition to a simple rote lightening of the blue record, that substituting some of the value of the red record into the blue record, typically about 30%, will have a proportionate effect to the amount of yellowishness of the teeth, varying from no effect if the teeth are already white or gray, and having the strongest effect if the teeth are deep yellow, and therefore modulate correction in proportion to how much it is needed.

In step 306, the data from the original image 18 is combined with the data for lightening the teeth 16e to create a corrected image 20e. The corrected image 20e can then be output to a location selected by the user, such as a display, storage device or other system.

Throughout the description and claims of this specification the word “comprise” and variation of that word, such as “comprises” and “comprising”, are not intended to exclude other additives, components, integers or steps. While the invention has been particularly shown and described in the foregoing detailed description, it will be understood by those skilled in the art that various other changes in form and detail may be made without departing from the spirit and scope of the invention as set forth in the appended claims.

What is claimed is:

1. A whiteness correction application operable to be loaded into an electronic system, wherein the whiteness correction application comprises:
receiving an original image;
automatically detecting one or more off white objects within the original image;
whitening at least a portion of the off white objects to create a corrected image that is more visually appealing than the original digital image; and
outputting the corrected image.

2. The whiteness correction application of claim 1, wherein the off white objects are one or more teeth.

3. The whiteness correction application of claim 2, wherein automatically detecting one or more teeth within the original image comprises:
analyzing the color variations within the original image to detect one or more objects that may be teeth;
determining whether the areas adjacent each object has skin tones; and
filtering the objects based on the areas adjacent each object to determine which objects are teeth.

4. The whiteness correction application of claim 3, further comprising determining whether the areas adjacent each object has foliage tones.

5. The whiteness correction application of claim 2, wherein automatically detecting one or more teeth within the original image comprises analyzing the features of each face to detect the teeth.

6. The whiteness correction application of claim 1, wherein whitening the objects comprises proportionally whitening each object based on a yellowishness of the object.

7. An electronic system comprising:
one or more processors;
a whiteness correction application operable to be loaded into the processors, wherein the whiteness correction application operates to:
receive an original image;
automatically detect one or more teeth within the original image;
whiten at least a portion of the off white objects to create a corrected image that is more visually appealing than the original digital image; and
output the corrected image.

8. The electronic system of claim 7, wherein the process of automatically detecting one or more teeth within the original image comprises:
analyzing the color variations within the original image to detect one or more objects that may be teeth;
determining whether the areas adjacent each object has skin tones; and
filtering the objects based on the areas adjacent each object to determine which objects are teeth.

9. The electronic system of claim 8, further comprising the process of determining whether the areas adjacent each object has foliage tones.

10. The electronic system of claim 7, wherein the process of automatically detecting one or more teeth within the original image comprises analyzing the features of each face to detect the teeth.

11. The electronic system of claim 7, wherein the electronic system is a computer electronic system.

12. A method for whitening certain off white objects within an original image comprising the steps of:
automatically detecting one or more off white objects within the original image; and
whitening at least a portion of the off white objects to create a corrected image that is more visually appealing than the original digital image.

13. The method of claim 12, wherein the off white objects are one or more teeth.

14. The method of claim 13, wherein the step of automatically detecting one or more teeth within the original image comprises:
analyzing the color variations within the original image to detect one or more objects that may be teeth;
determining whether the areas adjacent each object has skin tones; and
filtering the objects based on the areas adjacent each object to determine which objects are teeth.

15. The method of claim 14, further comprising the step of determining whether the areas adjacent each object has foliage tones.

16. The method of claim 13, wherein the step of automatically detecting one or more teeth within the original image comprises analyzing the features of each face to detect the teeth.

17. The method of claim 12, wherein the step of whitening the objects comprises proportionally whitening each object based on a yellowishness of the individual object.

18. The method of claim 12, wherein the teeth are lightened by lightening the blue record by approximately 30%.

19. The method of claim 12, wherein the object is a white of an eye.
